(19) United States
(12) Patent Application Publication
(10) Pub. No.: US 2023/0221415 A1
(43) Pub. Date: Jul. 13, 2023

(54) SYSTEMS AND METHODS OF MULTISPECTRAL SCANNING LIDAR

(71) Applicant: AEye, Inc., Dublin, CA (US)

(72) Inventors: Hod Finkelstein, Dublin, CA (US); Luis Dussan, Dublin, CA (US)

(21) Appl. No.: 17/570,916

(22) Filed: Jan. 7, 2022

(51) Int. Cl. G01S 7/481; G01S 17/89

(52) U.S. Cl. CPC G01S 7/4817; G01S 17/89; G02B 26/106

(57) ABSTRACT

Present implementations include a LIDAR system comprised of a scanning emitter and a static receiver having a detector pixel array. According to some aspects, the present embodiments reduce the physical dimensions of the detector array while maintaining effective optical performance of the system, thereby reducing overall cost, power and size of the system. In some embodiments, this is achieved by selectively emitting and receiving light in one or more wavelength bands corresponding to one or more sets of directions in which the light is emitted and received.

### TECHNICAL FIELD

The present disclosure relates generally to sensor devices, and more particularly to multispectral scanning light detection and ranging (LIDAR) with an active illumination system.

### BACKGROUND

Physical environments, including man-made environments for transportation, are becoming increasingly crowded, and complex. In addition to throughways for motor vehicles, such environments increasingly include throughways for pedestrians, human-powered vehicles, and mass transit vehicles. In addition, demands on motor vehicles to successfully navigate environments autonomously and independently are increasing rapidly, to reduce cognitive load on a vehicle driver or pilot. However, conventional vehicle systems cannot efficiently and effectively detect and react to objects in the environment surrounding the vehicle within computational, size and power resource requirements associated with vehicle systems. Thus, methods and systems for enabling more efficient and reliable autonomous vehicle navigation systems are desired.

### SUMMARY

Present implementations are generally directed at least to actively sensing objects in a portion of an environment using a Light Detection and Ranging (LIDAR) system. More particularly, one or more embodiments include a LIDAR system comprised of a scanning emitter and a static receiver having a detector pixel array. According to some aspects, the present embodiments reduce the physical dimensions of the detector array while maintaining effective optical performance of the system, thereby reducing overall cost, power and size of the system. In some embodiments, this is achieved by selectively emitting and receiving light in one or more wavelength bands corresponding to one or more sets of directions in which the light is emitted and received.

In some implementations, a method in accordance with embodiments includes preparing a plurality of light sources, each of the plurality of light sources having a respective wavelength, determining, by an active imaging system, a wavelength to be emitted based on a portion of a field of view to be scanned, selecting one of the plurality of light sources based on the determination, and scanning, by the active imaging system, the portion of the field of view using the selected one of the plurality of light sources.

In these and other implementations, an active imaging system according to embodiments comprises an emitter including a plurality of light sources, each of the plurality of light sources having a respective wavelength, and a scan controller configured to scan the portion of the field of view using a selected one of the plurality of light sources, and a controller including a wavelength selector configured to determine a wavelength to be emitted based on a portion of a field of view to be scanned and to select one of the plurality of light sources based on the determination.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 illustrates a block diagram of components of an example LIDAR system, in accordance with present implementations.

FIG. 2A illustrates an example block diagram of emitter of a LIDAR system, in accordance with present implementations.

FIG. 2B further illustrates an example mirror configuration implemented in the emitter of the example system of FIG. 2A, in accordance with present implementations.

FIG. 2C illustrates an example closed feedback system of a mirror of the emitter of the example system of FIG. 2A, in accordance with present implementations.

FIG. 3 illustrates a flow chart of the closed feedback system with reference to FIGS. 2A-2C, in accordance with the present implementations.

FIG. 4 illustrates the emitter and receiver in an example LIDAR system during an operating state, in accordance with present implementations.

FIG. 5A is an example of the emitter emitting different wavelengths used to illuminate different portions of a field of illumination, in accordance with present implementations.

FIG. 5B illustrates an example of engineering a wavelength in one direction, in accordance with present implementations.

FIG. 5C illustrates another example of engineering a wavelength in one direction, in accordance with present implementations.

FIG. 5D is an example of the emitter emitting engineered wavelengths in two dimensions, in accordance with present implementations.

FIG. 6A illustrates an example system with no refractive optical element before a collection lens.

FIG. 6B illustrates an example system with a refractive optical element placed before the collection lens.

FIG. 7 illustrates a flow chart for collecting reflected light beams during the operating state of the example LIDAR system illustrated in FIG. 4, in accordance with present implementations.

### DETAILED DESCRIPTION

Among other things, the present Applicant recognizes many opportunities for advancing the state of the art of actively sensing objects in a portion of an environment using a LIDAR system, as compared to previous approaches. For example, WO2020243130 describes one approach for reducing the size (and implicitly cost and electrical power) of an active illumination system to conserve Etendue. The system disclosed in this approach conserves Etendue while reducing the physical requirements of the active illumination system by using different wavelengths to illuminate portions of the field of view. However, the descriptions of this approach are limited to a monostatic architecture and requires a particularly arranged emitter array, refractive optical element(s), narrowly designed passband filter(s), and the like. Another approach for using different wavelengths is described in US20190361097 and AU2021202811, but is also limited to describing a monostatic architecture and suffers from complexities including additional or alternative optical elements such as prisms, diffraction gratings, etc.

Present implementations can achieve substantially real-time detection of objects in a portion of an environment using a LIDAR system having a bistatic architecture. The LIDAR system may be used to determine at least range and depth information of various objects in the environment. The LIDAR system employs one or more emitters (e.g., vertical-cavity surface emitting laser diodes (VCSELs), edge emitting laser diodes, fiber lasers) that emit one or more light pulses or light beams of particular wavelengths toward an environment and receives, via one or more receivers including one or more detector elements (e.g., photodiodes), a reflection (e.g., echo) of the light from an object in the environment. The optical energy associated with the reflection of the light from the environment is converted to electrical energy to determine information associated with the target (e.g., distance information, depth information, reflectivity, velocity).

To accurately determine information associated with an object, the reflections received at the receiver from the object should be received with minimal interference. Interference from other light sources may be reduced by employing a narrow-band spectral filter to selectively permit the system's emitter wavelengths to pass through the filter while rejecting other wavelengths. Accordingly, only relatively narrow spectral bands such as the reflected echo (and minimal other signals which form interference signal) pass through the filter. Interference may include other lasers from other laser systems, ambient light (e.g., solar light, light from other sources), and the like.

Conventional systems may be limited by the power of the emitter and/or laser, the size of the system, the cost of the system, the range detection, the illuminated field of view, the precision range and direction measurements, and the like. In conventional systems, the narrowband filter that is necessary to reject a broad range of light interference may often need to be large in order to conserve optical energy in the system, due to the principle of Conservation of Etendue. Additionally or alternatively, a detector element to detect a broader range of incident light beams may necessarily be large, for the reasons outlined below.

Etendue (also known as Light Throughput) is a property of light in an optical system, which characterizes how “spread out” the light is in area and angle. From the system point of view, the etendue equals the area of the entrance pupil times the solid angle the source subtends as seen from the pupil. Etendue never decreases in any optical system where optical power is conserved.

Narrowband filters are often constructed by forming layering thin-film dielectrics. This creates a stack which selectively transmits only those beams which satisfy a constructive interference condition. The latter is satisfied when the optical path lengths of light reflected from the various surfaces results in an integer multiple of wavelengths. The optical path is a function of the incident angle of the beam onto the filter surface, so narrowband filters typically require a narrow cone of incidence in order to attain a sharp passband.

Light can be assumed to be reflected from many targets in a Lambertian profile. The size of the collection lens of the lidar receiver is directly proportional to the percentage of that reflected light which can be collected by the system. Therefore, if the lens area is defined by the requirement to collect a certain percentage of reflected light from a certain target at a given range, and the field-of-view of the lidar system is also pre-defined, then the Etendue of the system must not fall below the product of the lens aperture area and the field-of-view.

In order to satisfy the passband transmission condition of the filter, the solid angle subtended by the incoming beam to the filter is set and is typically small. The ratio of the solid angle required by the filter to the field of view of the collection lens must be identical to the ratio of areas of the collection lens and the filter aperture, if Etendue (and optical energy in the system) is to be conserved. This often means that the filter aperture diameter must be made very large, which is undesirable for power, cost and size reasons; or that the bandpass of the filter much be widened, which results in more interference entering the receiver, and therefore requiring a higher emitter power to overcome such interference, thus increasing system power, size and cost, which is similarly undesirable.

The detector area is defined by multiple constraints. For a given field of view (FoV) in x and y, and a given resolution in x and y, the number of pixels in each axis of the pixel array are at least the ratio of the (FoV and resolution). Pixel area may be determined by the size of the active area as well as the size of in-pixel circuitry (or the larger of the two if the photodiode and the circuitry are stacked). If Etendue is to be conserved, then the angle subtended by the array multiplied by the array area must not fall below the Etendue at any of the other apertures of the system. This means that the ratio between the focal length of the collection lens and its diameter are defined by conservation of Etendue. However, when the ratio becomes very low, also known as high-numerical-aperture (high-NA) or low f#, the cost of generating and aligning the optical components becomes excessive. This can be addressed by increasing the area of the detector array, but such increase necessarily means larger size, cost and power, which are undesirable.

In an illustrative example, a receiver may have a field of view of 30×30 degrees (e.g., 900 square degrees) and a collection aperture area of one square inch. In order to attain a sufficiently narrow passband, the receiver's spectral filter may require an acceptance angle of 5×5 degrees (e.g., 25 square degrees). In order to conserver Etendue, the filter aperture must be at least 900/25×1=36 square inches, which, in many application may be excessively large.

In another illustrative example, if a receiver includes a small aperture such as a collection lens that images a large field of view (e.g., a large cone), and the LIDAR system includes a second aperture that requires approximately collimated light (e.g., a small half-cone angle), such as a narrowband spectral filter, then to conserve Etendue, the second aperture may necessarily be large because the solid angle of the second aperture is smaller.

According to some aspects, the present implementations reduce the Etendue of LIDAR systems while still conserving performance and power. This results in cost, power and size savings without incurring performance penalties. According to some aspects, the present implementations can achieve this by creating, timing and directing (or modulate or select) particular emitted wavelengths, and collecting them effectively, thereby reducing the size, cost and power consumption of the LIDAR system.

In some implementations. an active imaging system according to embodiments is located with, affixed to, integrated with, or associated with for example, an aerial or terrestrial vehicle. The vehicle can include an autonomous vehicle, a partially autonomous vehicle, a vehicle in which one or more components or systems thereof can operate at least partially autonomously, or any combination thereof, for example. The active illumination system can be employed in LADAR or LIDAR applications as discussed herein, and can scan across an environment to detect objects in a portion of an environment in which the vehicle is operating. In other implementations, an active imaging system is located with, affixed to, or associated with for example, a fixed object such as a security camera, 2D night vision camera, adverse weather imaging system, etc.

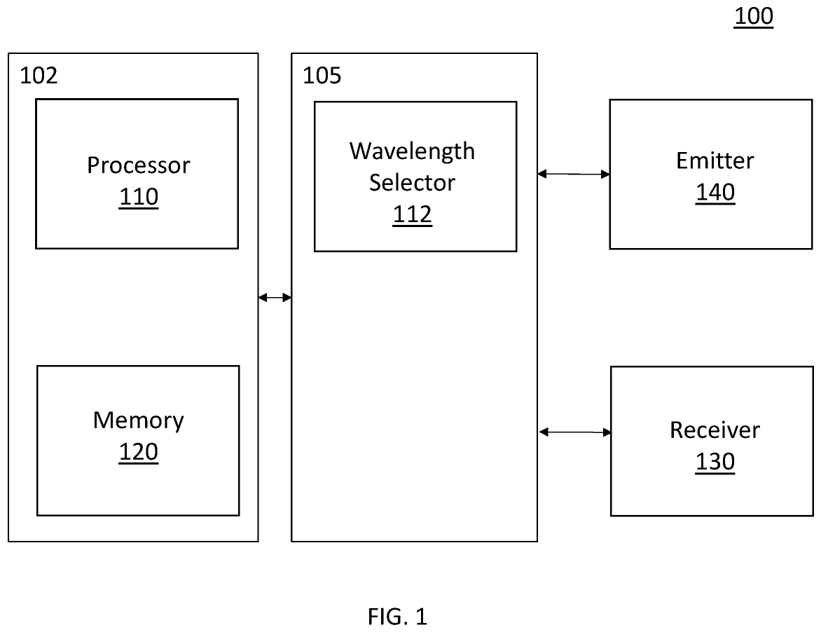

FIG. 1 illustrates a block diagram of components of an example bistatic active imaging system 100, in accordance with present implementations. As shown in this example, system 100 includes processor module 102 (including at least one system processor 110 and at least one system memory 120), controller 105, receiver 130 and emitter 140, some or all of which components are communicatively coupled together.

The receiver 130 can include one or more light capture elements configured to receive and detect light and projected by the emitter 140 and reflected from objects in an environment. The one or more light capture elements (e.g., detector(s)) may be arranged one- or two-dimensionally in an array, a grid or gridlike structure. The light capture elements can include but are not limited to, photosensitive electrical, electronic, or semiconductor devices. The optical energy received by the light capture elements may be converted into electrical energy for subsequent processing. For example, the electrical energy may be used by processing module 102 to generate at least one coordinate of an object in an environment based on one or more characteristics of the beam or pulse of light received at receiver 130.

The emitter 140 can transmit or project, for example, one or more light beams or pulses. The emitter 140 may include light projection element(s) configured to transmit a range of light (e.g. a range of wavelengths) and/or light projection element(s) configured to each transmit a particular wavelength (e.g., a center wavelength). The light projection elements of the emitter 140 may be lasers including, for example, light-emitting diodes, laser diodes and chemical laser emitters. For purposes of illustration, the light projection elements of the emitter 140 will be discussed in detail below in connection with an example implementation using one or more seed lasers and pump lasers. Each of the seed wavelengths of the seed laser will correspond to an emission wavelength.

In some implementations, one or more light projection elements of the emitter 140 can be configured to project one or more beams or pulses of light with respect to a coordinate system of the receiver 130. For example, each of the plurality of light beams or pulses can be associated with a coordinate in a multi-dimensional (e.g. polar) coordinate system. In such an example, the emitter 140 can project light beams having an elevation coordinate and an azimuth coordinate. The emitter 140 can determine the direction of projection by adjusting an orientation of a light projection array disposed therein and including one or more light projection elements. Additionally or alternatively, the emitter 140 may direct the beams from the light projection array using one or more reflective optical elements (e.g., mirrors). It is to be understood that the light projection elements are not limited to any particular orientation and are not limited to any particular coordinate systems discussed herein by way of example.

In some implementations, the system controller 105 controls the receiver 130 and the emitter 140. For example, the system controller 105 sets the timing signals for the emitter 140 and the receiver 130. The processor module 102 processes the raw output received from the receiver 130 and determines, generates, or otherwise produces a point cloud and feedback instructions (if any). The processor module 102 sends the feedback instructions to the system controller 105 to instruct the system controller 105 where to scan (e.g., where to direct the emitter 140 and the receiver 130). It should be noted that the term “scan” should not be considered limited to directing the emitter in sequentially and constantly equal changing angles. For example, the system controller 105 can control the emitter 140 using many alternatives such as scanning different sets of directions in different sequences (e.g. shots in a shot list).

In some implementations, the controller 105 may be employed to direct one or more laser beams in the emitter 140 using reflective optical elements (e.g., mirrors, prisms). The controller 105 may also be employed to manage (e.g. engineer) the wavelength of light emitted by active lasers (or other light sources or light projection elements of the emitter 140) via the wavelength selector 112. In an example to be described in more detail below, the controller 105 may activate a seed laser via the wavelength selector 112 as the controller 105 directs the one or more beams being projected by a first seed laser for a first set of directions. The controller 105 may further activate a second seed laser via the seed selector 112 as the controller 105 directs the one or more beams of the second seed laser for a second set of directions.

According to aspects of the example shown in FIG. 1, controller 105 is therefore adapted with or includes a wavelength selector 112. In embodiments to be described in more detail below, wavelength selector 112 may select among one or more light sources of the emitter 140 to project light beams having a selected wavelength. The wavelength selector 112 may individually select and switch light sources (e.g., seed lasers) sufficiently fast so as to replicate performance of a system having only one light source. In some implementations, the wavelength selector 112 may select one light source to be active at the emitter 140. In other implementations, the wavelength selector 112 may select more than one light source to be active at one time (e.g., during a transient time when one source is switching off and other is switching on) such that the overall emitter 140 power is maintained sufficiently constant.

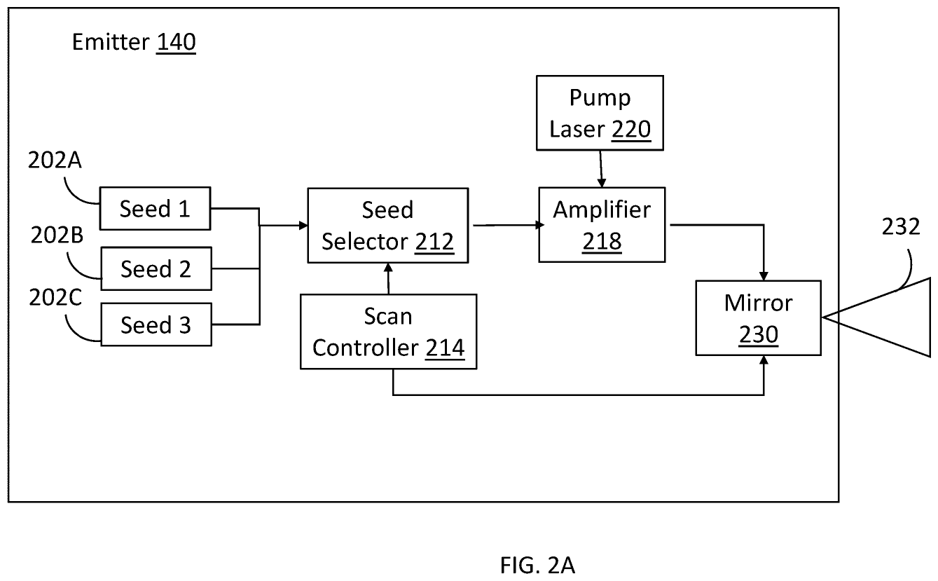

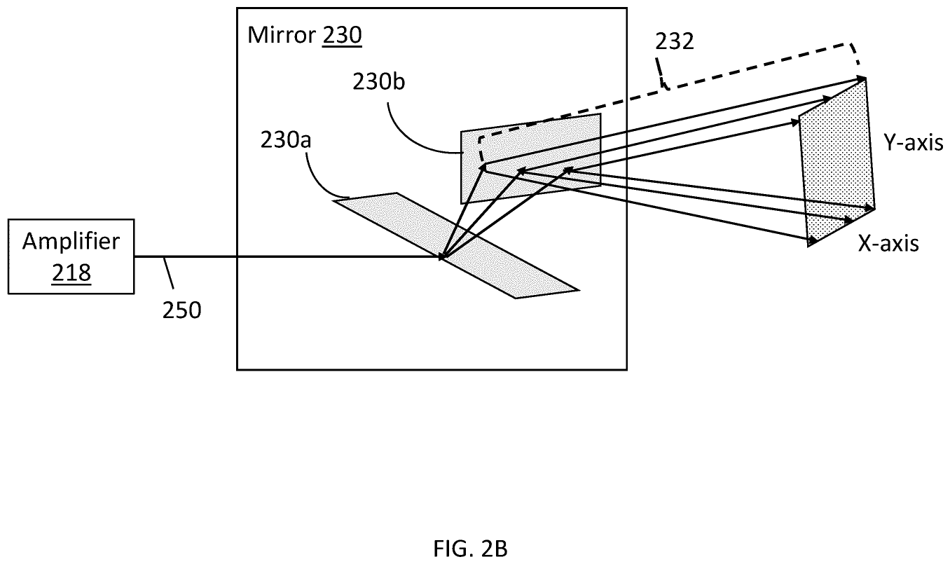

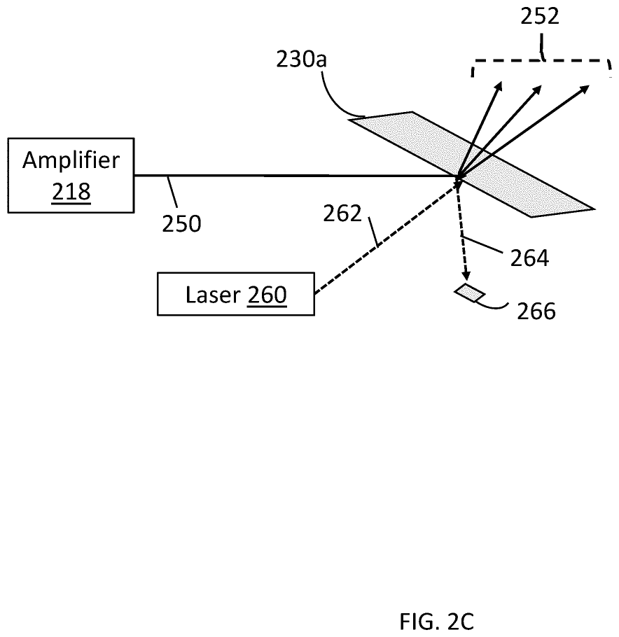

FIG. 2A illustrates an example block diagram of emitter 140 of an example bistatic active imaging system 100, in accordance with present implementations. As shown, the system projects light using seed lasers 202A, 202B, 202C. Each of the seed lasers 202A, 202B and 202C (collectively referred to as “seed lasers 202”) may be configured to transmit a particular wavelength. Each of the seed lasers 202 may be considered doped optical fiber lasers that contain a gain medium (and/or multiple stages of a gain medium). The seed lasers 202 may be used to excite specific wavelengths. The seed selector 212 may select which seed laser (or combination of seed lasers) to active to project a particular wavelength or wavelengths out of the system as controlled by wavelength selector 112 in controller 105. In some implementations, the selected one or more seed lasers 202 may be fed to an amplifier 218. In some implementations, the amplifier 218 may be in combination with pump laser 220. The amplifier 218 may be a 1:N stage fiber amplifier configured to generate a high power output from the selected seed lasers 202. The pump laser 220 may be configured to further boost the power and/or accuracy of the wavelength emitted by the seed lasers 202.

For example, a single high power light projection element may emit more powerful, but broad (e.g., scattered, less accurate) wavelengths. In contrast, a low power light projection element (e.g., a seed laser) configured to emit light at a particular (e.g., center) wavelength may have its power boosted by being fed into amplifier 218 and/or pump laser 220 such that the broadening of the center wavelength is reduced at high power. In other implementations, subsequent lasers (or other light projection elements or lenses) may be employed in addition to (or instead of) amplifier 218 and/or pump laser 220 to injection lock the center wavelength of the initial seed laser(s), minimizing the spread of the center wavelength.

The boosted optical signal (e.g., having the wavelength of the selected seed laser(s) 202) may be projected onto mirror 230 (or other reflective optical element). The mirror 230 is moved in one or more directions along one or more axes via scan controller 214 to direct the boosted optical wavelength into a field of illumination 232. The field of illumination 232 is the path of the projected light from the emitter. When the field of illumination is completely detected by the receiver, the field of illumination may be considered the field of view (e.g., the environment detected by the receiver). It should be apparent that, although shown separately for ease of illustration, scan controller 214 can be implemented partially or fully together with controller 105 as will be appreciated by those skilled in the art.

FIG. 2B further illustrates an example mirror configuration implemented in the emitter 140 of the bistatic active imaging system of FIG. 2A, in accordance with present implementations. As shown, the amplifier 218 is used to project light 250 to dual mirrors 230a and 230b (collectively referred to as “mirrors 230”), where mirrors 230a and 230b respectively direct the projected light 250 to create a field of illumination 232 modeled according to a x-axis and y-axis. Mirror 230a may be used to scan along the x-axis of the field of illumination 232, and mirror 230b may be used to scan along the y-axis of the field of illumination 232. The mirrors 230 may scan different areas of the field of illumination by mechanically moving (e.g., adjusting the pitch, tilt, yaw, roll of the mirrors). While mirrors 230a and 230b are shown, it should be appreciated that any number of mirrors be used to create the field of illumination 232.

Mirrors 230 are one example feature of an emitter 140 according to embodiments. Additionally or alternatively, other optical elements (e.g., prisms) may be used to direct different angles of projected light 250 to scan the field of illumination 232. Additionally or alternatively, other optical elements (e.g., lenses, filters) may be placed before or after mirrors 230. In some implementations, mirror 230a may be a different size from mirror 230b. In other implementations, mirror 230a may be the same size as mirror 230b. Further, mirror 230a may move at a different speed (or the same speed) as that of mirror 230b. The size/speed of adjustments made to the mirrors 230 may influence the size/scanning speed of the field of illumination 232.

In some implementations, the scan controller 214 mechanically drives the movement of the mirrors 230 using a driving voltage waveform. Moving the mirrors 230 modifies the field of illumination by modifying the scan angles of the projected light 250 from the amplifier 218 in FIG. 2B. The scan controller 214 may direct (or modify, adjust, move) each of the mirrors 230a and 230b to alter the projected angles (e.g., scan angles) of light from the initial projected light 250 such that different portions of the field of illumination 232 are illuminated.

The scan controller 214 may utilize feedback to correct the scan angles of the projected light 250 by iteratively adjusting at least one mirror (e.g., mirror 230a and/or mirror 230b). Employing a closed feedback loop allows the scan controller 214 refined control such that the scan controller 214 may direct beams of projected light to particular portions of the field of illumination 232 using the mirrors 230. The controller may update (or iteratively correct) the position of at least one mirror by adjusting the voltage waveforms applied to a mirror of the mirrors 230. In some implementations, each mirror may be associated with a unique feedback loop such that the scan controller 214 is able to independently monitor and adjust the position of each mirror.

FIG. 2C illustrates an example closed feedback system of a mirror 230a of the emitter 140 of the bistatic active imaging system of FIG. 2A, in accordance with present implementations. As illustrated in FIGS. 2B and 2C, the amplifier 218 may project light 250 towards mirror 230a. The mirror 230a may direct the projected light 250 into one or more reflected beams of light 252. In addition, a secondary laser 260 may transmit any type of laser 262 suitable for position detection to the backside of mirror 230a. The laser 262 may reflect off of the backside of mirror 230a to produce a reflected beam 264. The reflected beam 264 may be captured by a detector element 266. The detector element 266 may be one or more elements as part of a detector array (not shown) sensitive to the wavelengths emitted by the emitter. The detector element 266 may be configured to receive optical energy (e.g., light) and convert the optical energy into electrical energy (e.g., current). The detector elements 266 may be communicatively coupled to an integrated circuit to process the current.

The position of the mirror 230a will affect where the reflected beam 264 is received by the detector element 266. The scan controller 214 of FIG. 2A may be communicatively coupled to the detector element 266 (or the detector element array) such that the scan controller 214 may use the electrical energy received from reflected beam 264 to determine a position of the mirror 230a. For example, a particular detector element 266 receiving the reflected beam 264 in an array of detector elements (e.g., a detector element grid representing one or more coordinates of a mirror position) may indicate the one or more coordinates of the mirror 230a. In response to determining a position of the mirror 230a, the scan controller 214 may send a driving voltage waveform to refine or otherwise update the position of the mirror 230a. In some embodiments, the electrical signal from the detector element 266 may be amplified before being ingested by scan controller 214.

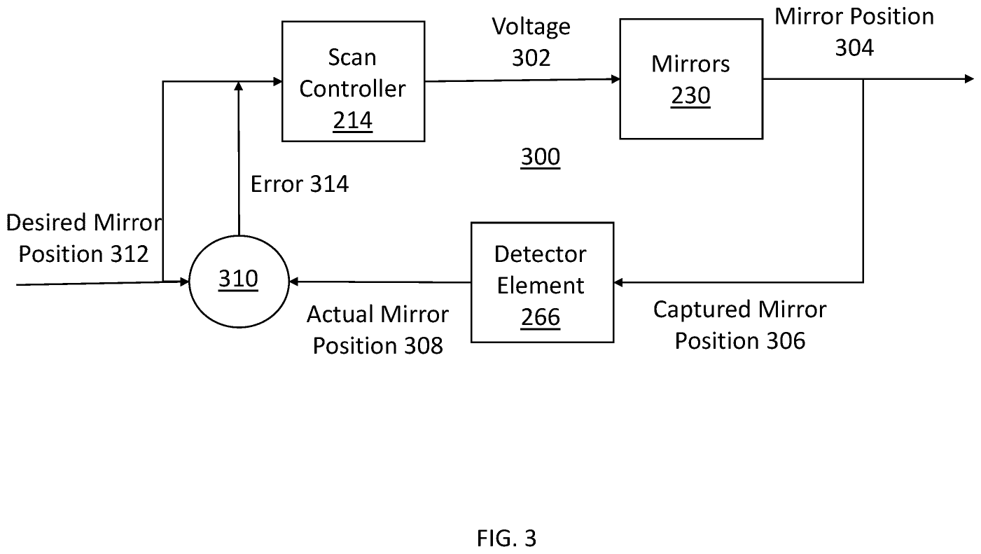

FIG. 3 illustrates a flow chart of the closed feedback loop with reference to FIGS. 2A-2C, in accordance with the present implementations. As described herein, one or more closed feedback loop may be used to tune the position of mirrors 230 such that beams are directed to particular fields of illumination. In some implementations, a first closed feedback loop may tune the position of mirror 230a and a second closed feedback loop may tune the position of mirror 230b.

The scan controller 214 will apply a signal 302 to mirrors 230 (or respective signals to each of the respective mirrors 230a and 230b) in an attempt to move the mirrors to a desired mirror position 312. The signals applied to the mirrors 230 will mechanically move the physical position of the mirrors (e.g., tilt the mirror, move the mirror left/right) in the active imaging system to a mirror position 304. In response to the mechanical movement of the mirrors 230 (or simultaneously with the mechanical movement of the mirrors 230), as described with reference to FIG. 2C, a secondary laser source positioned at the back side of mirrors 230 may project a laser 262 to determine a captured mirror position 306. One or more detector elements 266 may detect the reflected beam 264 such that the scan controller 214 may determine an actual position of the mirrors 308 from the captured mirror position 306.

The comparator 310 may compare the actual mirror position 308 to the desired mirror position 312 to determine an error 314. For example, the coordinates of the actual mirror position 308 may be compared to the coordinates of the desired mirror position 312. The coordinates of the actual mirror position 308 may be different from the coordinates of the desired mirror position 312 if a mirror is inadvertently moved. For example, a vehicle housing the active imaging system may bounce, causing the mirror 230 position to change.

The scan controller 214 may translate (or otherwise map) the coordinates into a voltage. For example, the scan controller 214 may implement proportional-integral-derivative (PID) control techniques. In an illustrative example, if error 314 is large, the scan controller 214 may generate a large voltage 302. If error 314 is small, the controller may generate a small voltage 302. Accordingly, the scan controller 214 determines the voltage 302 applied to move the mirrors 230 in response to the error 314.

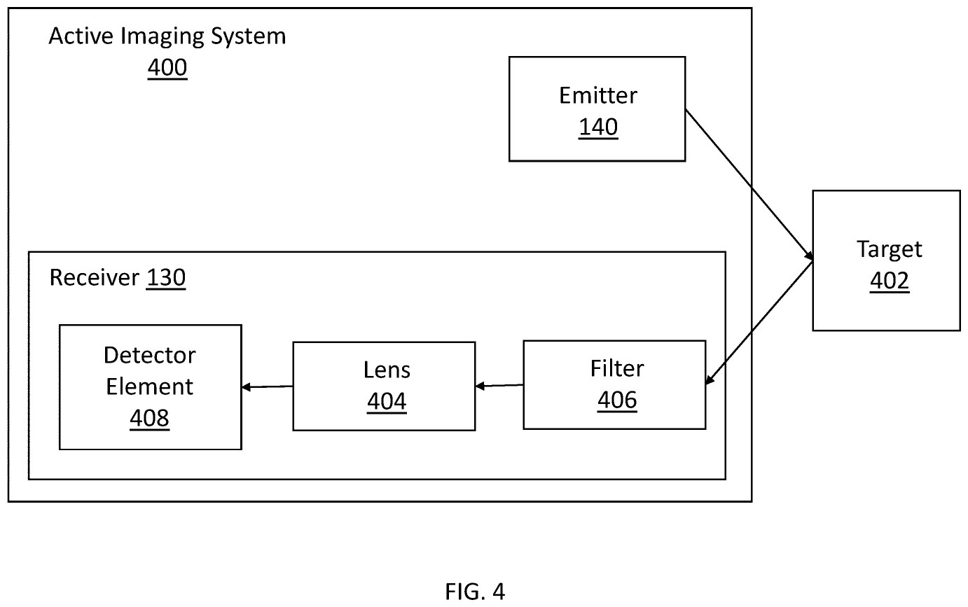

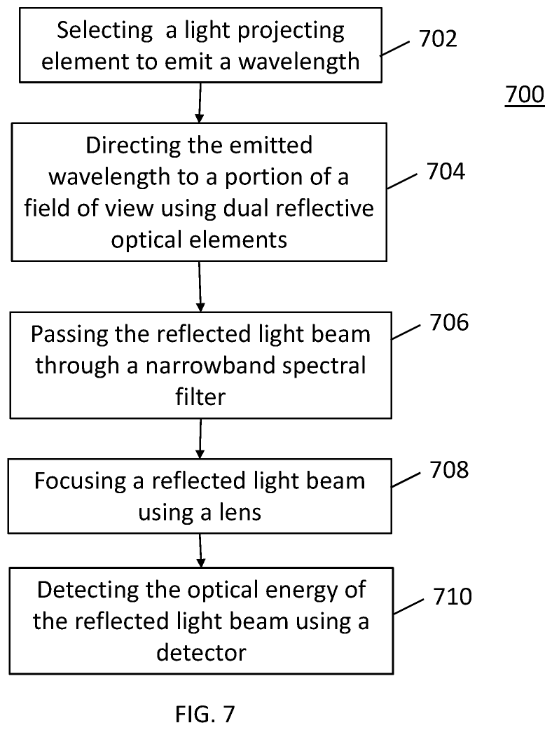

FIG. 4 illustrates the emitter and receiver in an example active imaging system 400 during an operating state, in accordance with present implementations. FIG. 7 illustrates a flow chart 700 for collecting reflected light beams during the operating state of the active imaging system illustrated in FIG. 4, in accordance with present implementations. In block 702 of FIG. 7, the active imaging system selects a light projecting element to emit a wavelength. Referring to FIG. 4, the emitter 140 (or seed lasers of the emitter 140, selected by the seed selector 212 and scan controller 214 of FIG. 2A) may project light having a wavelength onto a target 402 outside of the active imaging system 400. The emitter 140 may include one or more light projecting elements (e.g., seed lasers, emitters) configured to illuminate a field of illumination. In some embodiments, one or more refractive optical elements (e.g., filters or lenses) may be configured to interact with the projected light from the light projecting elements of the emitter 140 before the projected light exists the active imaging system 400. For example, a filter may be employed to modify the projected light such that the light exiting the active imaging system 400 is a particularly engineered wavelength, where the particular wavelengths are configured to illuminate particular fields of illumination (and subsequently particular fields of view of the target 402).

Referring back to FIG. 7, in block 704, the emitter 140 may direct the emitted wavelength to a portion of the field of view using dual reflective optical elements (e.g., mirrors 230). The mirrors may direct the emitted wavelengths to different angles, illuminating different portions of the field of illumination. The emitter 140 may thus scan a given field of view by selecting light projecting elements (or specific wavelengths or wavelengths bands emitted by one or more such projecting elements) to be emitted for a portion of the given field of view and directing the wavelengths to the portion of the field of view by mechanically moving mirrors. It should be apparent that, although blocks 702 and 704 are described separately, they may be performed substantially at the same time. For example, as discussed more fully above, the wavelength projected in block 702 is selected in correspondence with the direction used by the emitter 140 in block 704. Additionally or alternatively, the direction used in block 704 may correspond to a direction of a direction-dependent transmission band of a filter used in block 702.

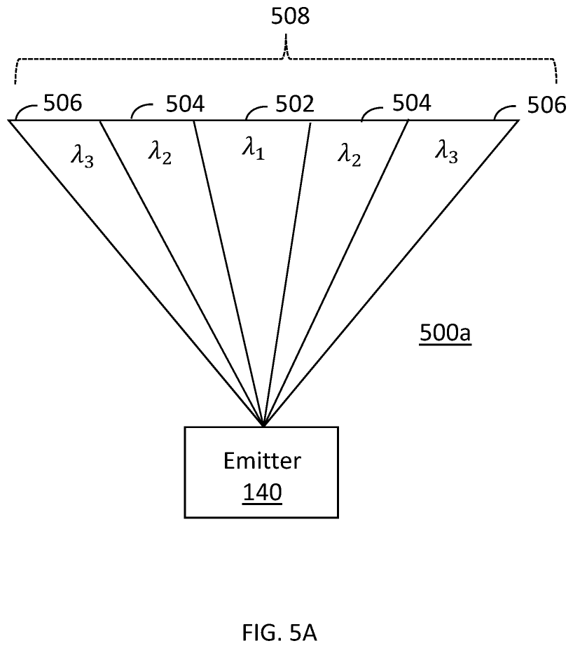

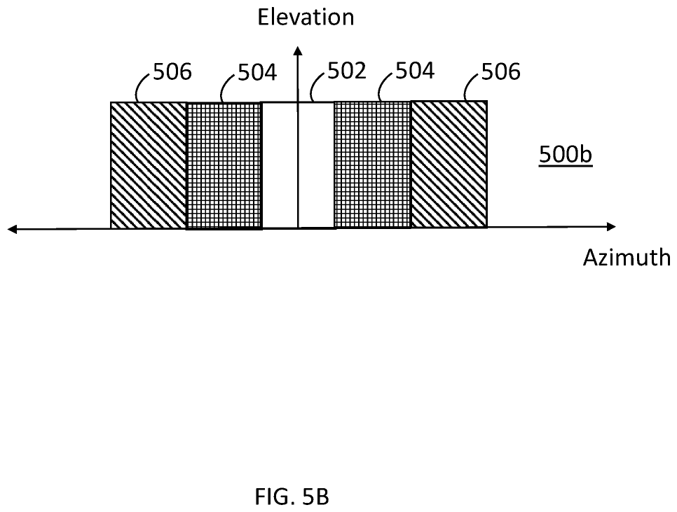

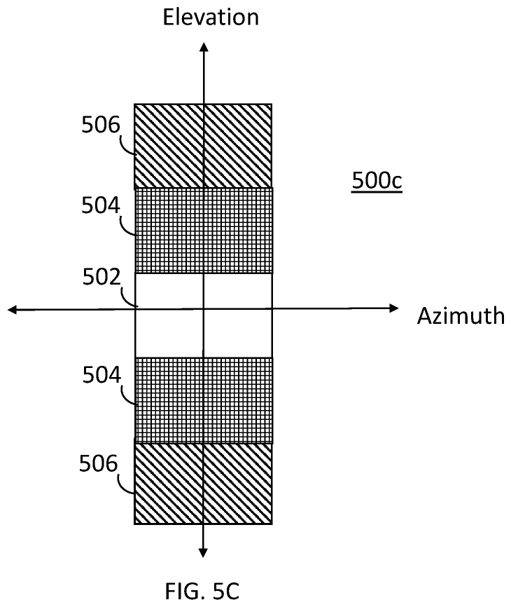

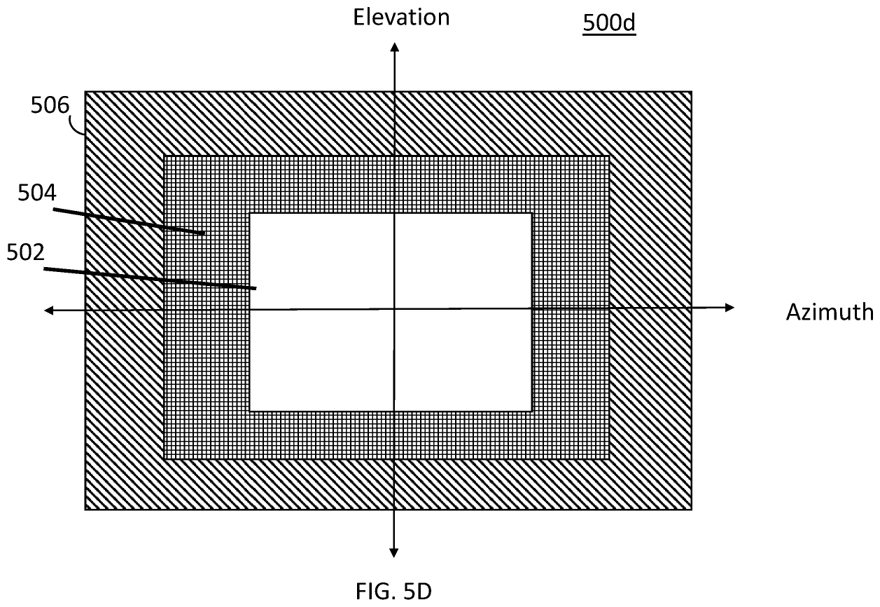

In addition to directing the emitted wavelength(s) to portions of a field of view, the emitter 140 may thus select (or engineer) the emitted wavelengths for the targeted portions of the field of view. The illumination of different portions of a field of illumination results in different portions of a field of view being scanned (or imaged). FIGS. 5A-5D illustrates an example of the emitter engineering wavelengths corresponding to different cone angles of a field of illumination, in accordance with present implementations. The emitter 140 may selectively emit unique angle bands in one or two axes. FIG. 5A is an example 500a of the emitter 140 emitting different wavelengths used to illuminate different portions of a field of illumination 508. As shown, the emitter 140 may emit a first wavelength 502 at a central angle, a second wavelength 504 for medium periphery angles, and a third wavelength 506 for far peripheral angles. As shown, wavelength 502 is larger than wavelength 504, and wavelength 504 is larger than wavelength 506. The emitter 140 may emit such different wavelengths (e.g., using seed lasers 202 and/or a combination of seed lasers) depending on the angle used to illuminate a portion of the field of illumination. As described herein, the angles used to illuminate the portions of the field of illumination are dictated by the position of the mirrors 230. In particular, because of the known position of the mirrors (e.g., using the closed feedback loop as described in FIG. 3) the scan controller 214 may select light projecting elements (e.g., seed lasers 202 selected using the seed selector 212) to illuminate particular portions of the field of illumination. In an example, because the scan controller 214 is aware of the mirror position and is responsible in part for the scanning the field of view, the scan controller 214 may activate a light projecting element configured to output a high wavelength for smaller incident angles (e.g., wavelength 502) and activate a light projecting element configured to output a short wavelength for larger incident angles (e.g., wavelength 506). It should be appreciated that the field of illumination may be partitioned into any number of portions with any number of wavelengths and angles engineered to illuminate those portions.

FIGS. 5B and 5C illustrate examples 500b and 500c of engineering a wavelength in one direction, in accordance with present implementations. As shown in FIG. 5B, the field of view is larger in the x-axis than in the y-axis (e.g., the range of azimuth angles scanned is larger than the range of elevation angles scanned). As described herein, the emitter 140 is capable of scanning the x-axis and the y-axis using the dual mirrors (e.g., mirrors 230a and 230b) positioned by scan controller 214. For example, the active imaging system may scan a field of view of 120 degrees on the azimuth and 25 degrees in elevation. In this example, the emitter 140 may not engineer the wavelengths in the y axis because the range of angles is not large. Accordingly, the emitter 140 may engineer the wavelengths in the x-axis by controlling the wavelengths of the seed lasers 202 and the position of the mirrors 230. For example, the emitter 140 may engineer the longer wavelength 502 at shorter angles of incidence.

In contrast, as shown in FIG. 5C, the field of view angle is larger in the y-axis than in the x-axis (e.g., the range of elevation angles scanned is larger than the range of azimuth angles scanned). In this example, the emitter 140 may not engineer the wavelengths in the y-axis.

FIG. 5D is an example 500d of the emitter 140 emitting engineered wavelengths in two dimensions, in accordance with present implementations. As shown, the emitter 140 emits wavelengths using an azimuth scan, or a scan along the x-axis and an elevation scan, or a scan along the y-axis.

Among other things, the present Applicant recognizes that as an optical interference filter is tilted away from normal, the transmission spectrum is “blue shifted,” which means the spectral features shift to shorter wavelengths. This angle shift becomes more pronounced with increasing angles of incidence. Effective refractive index can be used to predict angle shift, however, this variable is design-dependent, wavelength-dependent, and polarization-dependent. Therefore, different values for each optical filter design and polarization state will need to be determined to predict the shift of each spectral feature of interest.

The present embodiments ensure that the wavelength of the rays impinging on the filter match this wavelength-dependent transmittance function. Conservation of Etendue can be employed per wavelength. Since the filter “sees” each wavelength at only a narrow solid angle band, the Etendue of the filter aperture, which typically is the limiting parameter for the system, is greatly reduced, resulting in the desired cost, size and power reduction for the overall system. The size of one or more components in the receiver 140 of the present embodiments may be reduced because the emitter 140 engineers the emitted wavelengths and directs the engineered wavelengths to scan different portions of the field of illumination. One benefit of engineering the wavelengths for particular portions of the field of illumination is gaining apriori knowledge of reflected wavelengths that may be received by the receiver 130. That is, the wavelengths reflected from target 402 are within a desired spectral range when the receiver 130 receives the reflected light because of the engineered wavelengths emitted by the emitter 140. For example, the emitter 140 may be configured to emit short wavelengths to illuminate a central angle of a field of illumination, and long wavelengths to illuminate angles at a peripheral of the field of illumination. The reflected angles from the emitted short wavelengths may be received at the receiver 130 and the reflected angles from the longer wavelengths may be received at the receiver 130 close to the normal incident. The wavelengths emitted from emitter 140 are engineered to target portions of the field of illumination and reflect particular angles back to the receiver 130. When the projected beams of light having a particular wavelength encounter the target 402, the light is reflected off of the target 402. The illuminated portions of the field of view (e.g., the reflected light, or echoes) are received at the receiver 130 at angles of incidence that may be designed to correspond to passbands of filter 406 in the receiver 130.

Referring to FIGS. 4 and 7, in block 706, the receiver 130 of the active imaging system 400 receives the reflected light at a narrowband spectral filter 406 or other refractive optical element such as a prism, high-refractive-contrast slab, or other element that is designed with a difference in refractive index between the emitter's wavelengths, allowing for a compression in the cone of angles entering the receiver 130. The received reflected light beam may be passed through the filter 406.

In some implementations, the filter 406 may be embedded in a lens such that the lens collects light at the receiver 130, but the filter 406 restricts the collected light to the reflected light from the target 402. In these implementations, the larger the lens, the more optical power can be captured. Similarly, the larger the filter 406, the more interference can be reduced (e.g., the more narrow the passband). The size of the lens and/or filter is proportional to the cost and size of the active imaging system.

A narrow band of spectral energy may pass through filter 406 in response to satisfying a filter condition. For example, shorter wavelengths may satisfy a constructive interference by traversing a longer diagonal within the filter. To satisfy the constructive interference condition and be passed through the filter 406, the light should be collimated or approximately collimated with a controller chief ray angle. The light does not have to enter the filter normally, but the rays of the light may come in at approximately the same angle in order to satisfy the condition of the filter. In some implementations (e.g., long-range LIDAR), reflected light can be considered collimated. However, the chief ray angle may depend on the field of view. Accordingly, the field of view to be illuminated may dictate how the emitter 140 engineers the wavelength such that the reflected light beam received at receiver 130 is received in a desired spectral range to pass through the filter 406.

The emitter 140 may engineer a wavelength to align with a desired wavelength according to the filter 406 properties. For example, given an all-dielectric Fabry-Perot filter, the central wavelength shifts lower in wavelength with an increase in incident angle. As discussed above, the amount of wavelength shift is dependent upon the incident angle and the effective index of the filter. In an example, Expression (1) may be used to determine the wavelength shift of a filter in collimated light with incident angles up to 15 degrees.

$${λ}_{θ} = {{λ}_{0} [ 1 - {( \frac{{N}_{e}}{{N}^{*}} )}^{2} {Sin}^{2} θ ]}^{\frac{1}{2}} . \qquad ( 1 )$$

In Expression (1), λ_{θ} is the wavelength of the angle of incidence, λ₀ is the wavelength at normal incidence, Nₑ is the refractive index of the external medium, N* is the effective refractive index of the filter, and θ is the angle of incidence.

In an example, the emitter 140 may emit a first wavelength corresponding to the center of the passband of the spectral filter when the field to be illuminated (e.g., the portion of the field of illumination) is directed to small angles with respect to the normal to the receiver 130. The emitter 140 may emit a second wavelength when the field to be illuminated is directed at larger angles such that the condition of Expression (1) is approximately satisfied for those larger angles. The engineered wavelengths emitted by emitter 140 allow the maximum light throughput to be calculated for each wavelength, instead of an entire field of illumination. Accordingly, the size of one or more components at the receiver 130 may be reduced while conserving Etendue because each wavelength emitted by the emitter 140 scans a smaller cone of angles. While described as emitting one wavelength, it should be appreciated that more than one wavelength may be emitted.

For example, the filter 406 may be made smaller for the same passband as compared to a system with a fixed wavelength of emission for all fields (or portions) of the field of illumination. The filter 406 may be configured to receive the reflected light beams having the engineered wavelengths corresponding to portions of the field of view. The filter 406 may be configured such that the approximately normal incident echoes fit within the filter 406 incidence passband, and the non-normal incident echoes fit within the filter 406 passband for the respective angles of incidence.

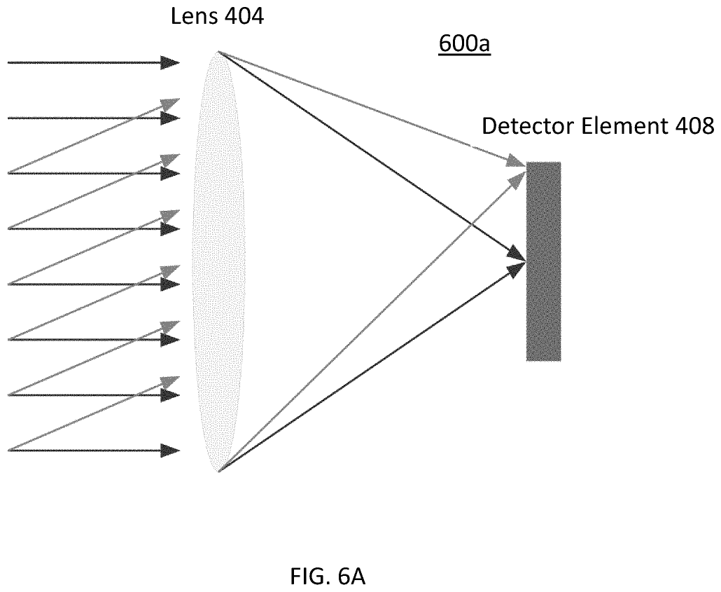

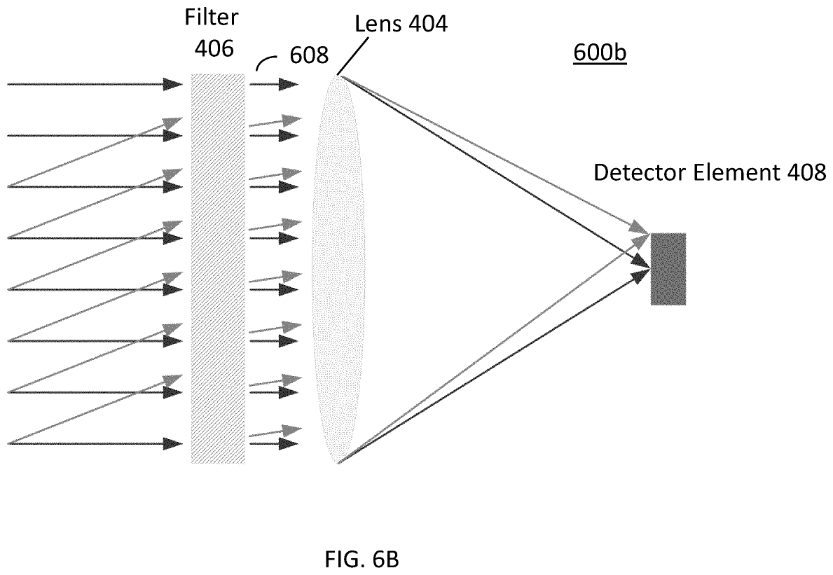

In a different example, the detector element 408 may be made smaller using a filter element configured for specifically engineered wavelengths. FIGS. 6A and 6B illustrate the effect of a filter designed with apriori knowledge of the engineered emitted wavelengths on the size of a detector element of the receiver 130. FIG. 6A illustrates an example system 600a with no refractive optical element before a collection lens 404, while FIG. 6B illustrates an example system 600b with a refractive optical element placed before the collection lens 404.

As shown in FIG. 6A, a system with an angle-dependent emission spectrum may require a larger detector (e.g., detector element 408) to detect the wavelengths passing through the lens 404. The detector half diameter h may need to satisfy certain geometric constraints such as h=fθ, h=f tan θ, or h=f sin θ, where f is the focal length of the lens that may be constrained by manufacturability, cost, or physical constraints and θ is the half angle of the field of view. In addition to the geometrical constraints, the energy conservation (or Etendue conservation) may dictate that

Areaₗₑₙₛ×Ωₗₑₙₛ=Area_{detector}×Ω_{detector} (2),

where Ω represents the solid angle imaged by an aperture in the system.

As shown in FIG. 6B, by inserting a filter 406 before the lens 404, the effective Etendue of the system is reduced. The filter 406 may be configured to have a different index of refraction for different wavelengths (e.g., the refractive index is wavelength dependent) allowing different wavelengths to get refracted at different angles. As described herein, the emitter 140 may be configured to emit different wavelengths to illuminate different portions of a field of illumination (e.g., each wavelength images a small cone of angles). Accordingly, shorter wavelengths that are reflected from the target 402 to the receiver 140 have higher incident angles. The filter 406 may refract shorter wavelengths more than longer wavelengths, further collimating the light 608 before the light hits the lens 404. That is, the wavelengths which were emitted toward larger angles are refracted more than those which were emitted towards smaller angles. The engineered wavelengths from the emitter 140 may be considered a priori knowledge such that a filter 406 may further reduce the cone angle that hits the lens 404, further reducing the size and cost of the active imaging system. That is, the filter 406 selectively refracts different wavelengths by different amounts to further reduce the cone angle according to a priori knowledge of the wavelengths that should be received by the receiver 130.

Etendue of the system for each wavelength is maintained because the acceptance angle into the system for each wavelength is smaller than that of FIG. 6A. By reducing the Etendue of the lens 404 (e.g., reducing the cone angle hitting the lens 404), the area of the detector element 408 may be reduced, subsequently reducing the cost, power, or overall system dimensions.

The detector elements 408 may be the same detector elements or different detector elements as in the emitter 140 and used for the closed feedback loop (e.g., detector elements 266 in FIG. 3). The detector elements 408 may be oriented towards the target 402 to receive the reflected light from the target 402 for subsequent processing (e.g., distance determinations, depth determinations, 3D point cloud representation of the target 402).

Referring back to FIG. 7, in block 708, the lens 404 may focus the light on the detector element 408 (or other focal plane array). The lens 404 focuses the reflected light beam light that passed through the filter 406 to the detector 408 such that the detector 408 is able to accurately capture the received light. Focusing the light on the detector 408 may result at least in more accurate subsequent processing using the optical energy (converted into electrical energy) detected at the detector 408. For example, the active imaging system may determine a distance to the target 402, determine a depth of the target 402, and the like. In block 710, the detector detects the optical energy hitting the detector and converts the optical energy into electrical energy for subsequent processing. For example, a read-out integrated circuit may generate range and reflectivity information about the target 402.

The target 402 may represent one object, multiple objects, an environment (e.g., a scene) and/or a portion of the environment. As an example, the target 402 can include a ground surface, vehicles, pedestrians, bicycles, trains, trees, traffic structures, roadways, railways, buildings, blockades, barriers, and benches. The target 402 may move or be stationary. The target 402 will reflect one or more beams of light back into the active imaging system into the receiver 130.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably coupleable,” to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A method comprising:
preparing a plurality of light sources, each of the plurality of light sources having a respective wavelength;
determining, by an active illumination system, a wavelength to be emitted based on a portion of a field of view to be scanned;
selecting one of the plurality of light sources based on the determination; and
scanning, by the active illumination system, the portion of the field of view using the selected one of the plurality of light sources.

2. The method of claim 1, wherein scanning includes positioning one or more reflective optical elements of the active illumination system into a desired position, the desired position corresponding to a coordinate within a coordinate space having two or more dimensions in the field of view.

3. The method of claim 2, wherein the one or more reflective optical elements comprise mirrors that are configured to controllably direct light from the selected one of the plurality of light sources in a direction corresponding to the coordinate.

4. The method of claim 3, wherein the coordinate comprises an azimuth and elevation in the coordinate space.

5. The method of claim 2, wherein determining the wavelength to be emitted comprises:
determining a wavelength associated with the coordinate; and
identifying the selected one of the plurality of light sources by comparing the determined wavelength with the respective wavelengths of the plurality of light sources.

6. The method of claim 1 further comprising:
determining, by the active illumination system, a second wavelength to be emitted based on a second portion of a field of view to be scanned different from the portion of the field of view;
selecting a different one of the plurality of light sources based on the determination; and
scanning, by the active illumination system, the second portion of the field of view using the different one of the plurality of light sources.

7. The method of claim 1 further comprising:
receiving, by an active imaging system, a reflected light beam having an incoming direction within the field of view;
configuring an optical element to have an optical characteristic based on the incoming direction;
passing, by the active imaging system, the reflected light beam through the optical element
detecting, by the active imaging system, the reflected light beam using a detector element after passing through the optical element.

8. The method of claim 7, further comprising:
focusing, by the active imaging system, the reflected light beam using a collection lens after passing through the optical element; and
detecting the reflected light beam using the detector element after passing through the optical element and the collection lens.

9. The method of claim 8, wherein the optical element comprises a refractive optical element, the method further comprising configuring the refractive optical element to refract the reflected light beam based on the incoming direction.

10. The method of claim 9, wherein a size of the detector element is based on, in part, a size of the collection lens.

11. The method of claim 7, wherein the optical element comprises a spectral filter, the method further comprising configuring the spectral filter to have a passband that is dependent on the incoming beam direction.

12. The method of claim 7, wherein a size of the detector element is based on, in part, the field of view.

13. An active imaging system comprising:
an emitter including:
a plurality of light sources, each of the plurality of light sources having a respective wavelength, and
a scan controller configured to scan the portion of the field of view using a selected one of the plurality of light sources; and
a controller including a wavelength selector configured to determine a wavelength to be emitted based on a portion of a field of view to be scanned and to select one of the plurality of light sources based on the determination.

14. The system of claim 13, further comprising one or more reflective optical elements, and wherein the scan controller is configured to position the one or more reflective optical elements into a desired position, the desired position corresponding to a coordinate within a coordinate space having two or more dimensions in the field of view.

15. The system of claim 14, wherein the one or more reflective optical elements comprise mirrors that are configured to controllably direct light from the selected one of the plurality of light sources in a direction corresponding to the coordinate.

16. The system of claim 14, wherein the coordinate comprises an azimuth and elevation in the coordinate space.

17. The system of claim 13, wherein the plurality of light sources comprise seed lasers, the system further comprising a pump laser configured to pump light from the seed lasers.

18. The system of claim 13, further comprising:
a receiver configured to receive a reflected light beam having an incoming direction within a field of view, the receiver including:
an optical element configured to have an optical characteristic based on the incoming direction; and
a detector element configured to detect the reflected light beam after passing through the optical element.

19. The system of claim 18, further comprising a collection lens configured to focus the reflected light beam toward the detector element after passing through the optical element.

20. The system of claim 19, wherein the optical element comprises a refractive optical element configured to refract the reflected light beam based on the incoming direction.

21. The system of claim 19, wherein a size of the detector element is based on, in part, a size of the collection lens.

22. The system of claim 18, wherein the optical element comprises a spectral filter configured to have a passband that is dependent on the incoming direction.

23. The system of claim 18, wherein a size of the detector element is based on, in part, the field of view.
